(19) United States
(12) Patent Application Publication
(10) Pub. No.: US 2025/0227190 A1
(43) Pub. Date: Jul. 10, 2025

(54) IMAGE PROCESSING APPARATUS, WIRELESS COMMUNICATION TERMINAL, AND PROGRAM

(71) Applicant: KYOCERA CORPORATION, Kyoto-shi (JP)

(72) Inventors: Shingo ITO, Kyoto-shi (JP); Hiroshi OKA, Kyoto-shi (JP); Shigeki TAKAYA, Yokohama-shi (JP); Daisuke HARA, Kirishima-shi (JP)

(21) Appl. No.: 19/094,991

(22) Filed: Mar. 30, 2025

Related U.S. Application Data
(63) Continuation of application No. PCT/JP2022/036783, filed on Sep. 30, 2022.

(51) Int. Cl. H04N 1/44; G06F 3/12; H04N 1/00; H04N 1/32; H04W 12/06

(52) U.S. Cl. CPC H04N 1/4426; G06F 3/1203; G06F 3/1236; G06F 3/1286; G06F 3/1292; H04N 1/00204; H04N 1/32101; H04N 1/4433; H04W 12/06; H04N 2201/0075; H04N 2201/3269

(57) ABSTRACT

In a first aspect, an image processing apparatus includes an image processor that executes image processing including printing and/or scanning, a presentation unit that presents first authentication information that can be acquired by a wireless communication terminal, a communicator that receives, from the wireless communication terminal through wireless communication with the wireless communication terminal, an image processing instruction instructing execution of the image processing and second authentication information associated with the image processing instruction, and a controller that performs authentication processing of checking whether the received second authentication information matches the presented first authentication information. The controller controls, based on success in the authentication processing, the image processor to execute the image processing corresponding to the received image processing instruction.

### RELATED APPLICATIONS

The present application is a continuation based on PCT Application No. PCT/JP2022/036783, filed on Sep. 30, 2022. The content of which is incorporated by reference herein in their entirety.

### TECHNICAL FIELD

The present disclosure relates to an image processing apparatus, a wireless communication terminal, and a program.

### BACKGROUND

An image processing apparatus such as a printer includes a display that displays an image including various types of information. A display of the image processing apparatus is lower in resolution, lower in refresh rate, and/or smaller in size than a display of a wireless communication terminal such as a smartphone or a tablet terminal. Accordingly, the image processing apparatus is generally lower in operability than the wireless communication terminal.

In recent years, an image processing system has been realized in which a wireless communication terminal is caused to display an operation screen of the image processing apparatus, and the wireless communication terminal operates the image processing apparatus through wireless communication between the image processing apparatus and the wireless communication terminal. Such an image processing apparatus may include a display that is as small as possible to display a two-dimensional code (for example, see Patent Documents 1 and 2). Alternatively, such an image processing apparatus may have a configuration with no display.

### CITATION LIST

### Patent Literature

Patent Document 1: JP 2021-9467 A
Patent Document 2: JP 2021-22123 A

### SUMMARY

In a first aspect, an image processing apparatus includes an image processor configured to execute image processing including printing and/or scanning, a presentation unit configured to present first authentication information configured to be acquired by a wireless communication terminal, a communicator configured to receive, from the wireless communication terminal through wireless communication with the wireless communication terminal, an image processing instruction instructing execution of the image processing and second authentication information associated with the image processing instruction, and a controller configured to perform authentication processing of checking whether the received second authentication information matches the presented first authentication information. The controller controls, based on success in the authentication processing, the image processor to execute the image processing corresponding to the received image processing instruction.

In a second aspect, a wireless communication terminal includes a communicator configured to perform wireless communication with an image processing apparatus configured to execute image processing including printing and/or scanning, an acquiring unit configured to acquire authentication information presented by the image processing apparatus, and a controller configured to control the communicator to transmit, to the image processing apparatus through the wireless communication, the acquired authentication information and an image processing instruction instructing execution of the image processing.

In a third aspect, a program causes an image processing apparatus configured to execute image processing including printing and/or scanning to execute presenting first authentication information configured to be acquired by a wireless communication terminal, receiving, from the wireless communication terminal through wireless communication with the wireless communication terminal, an image processing instruction instructing execution of the image processing and second authentication information associated with the image processing instruction, performing authentication processing of checking whether the received second authentication information matches the presented first authentication information, and executing, based on success in the authentication processing, the image processing corresponding to the received image processing instruction.

In a fourth aspect, a program causes a wireless communication terminal to execute performing wireless communication with an image processing apparatus configured to execute image processing including printing and/or scanning, acquiring authentication information presented by the image processing apparatus, and transmitting, to the image processing apparatus through the wireless communication with the image processing apparatus, the acquired authentication information and an image processing instruction instructing execution of the image processing.

### BRIEF DESCRIPTION OF THE DRAWINGS

FIG. 1 is a diagram illustrating a configuration example of an image processing system according to an embodiment.

FIG. 2 is a diagram illustrating a configuration example of the image processing apparatus according to the embodiment.

FIG. 3 is a diagram illustrating a configuration example of a wireless communication terminal according to an embodiment.

FIG. 4 is a diagram illustrating a first operation example of the image processing system according to the embodiment.

FIG. 5 is a diagram illustrating a second operation example of the image processing system according to the embodiment.

FIG. 6 is a diagram illustrating a variation of the image processing apparatus according to the embodiment.

FIG. 7 is a diagram illustrating a variation of the wireless communication terminal according to the embodiment.

FIG. 8 is a diagram illustrating a variation of the image processing system according to the embodiment.

### DESCRIPTION OF EMBODIMENTS

Embodiments are described with reference to the drawings. In the description of the drawings, the same or similar parts are denoted by the same or similar reference signs. Overview of Embodiment

An image processing apparatus may establish wireless communication connections with a plurality of wireless communication terminals and receive image processing instructions from the plurality of wireless communication terminals. For example, after a user of a certain wireless communication terminal sets a document or paper on the image processing apparatus and before the wireless communication terminal transmits an image processing instruction to the image processing apparatus, a different wireless communication terminal may transmit an image processing instruction (for example, a scanning instruction, a fax instruction, or a printing instruction) to the image processing apparatus.

In such a case, the image processing apparatus executes image processing corresponding to the image processing instruction from the different wireless communication terminal, that is, image processing not intended by the user who has set the document or the paper. A problem in this case is that the user may suffer disadvantage, impairing convenience of the user.

According to the present disclosure, the image processing apparatus can further improve the convenience of the user. The image processing apparatus includes an image processor that executes image processing including printing and/or scanning, a presentation unit that presents first authentication information that can be acquired by a wireless communication terminal, a communicator that receives, from the wireless communication terminal through wireless communication with the wireless communication terminal, an image processing instruction instructing execution of the image processing and second authentication information associated with the image processing instruction, a controller that performs authentication processing of checking whether the received second authentication information matches the presented first authentication information. The controller controls, based on success in the authentication processing, the image processor to execute the image processing corresponding to the received image processing instruction.

### System Configuration Example

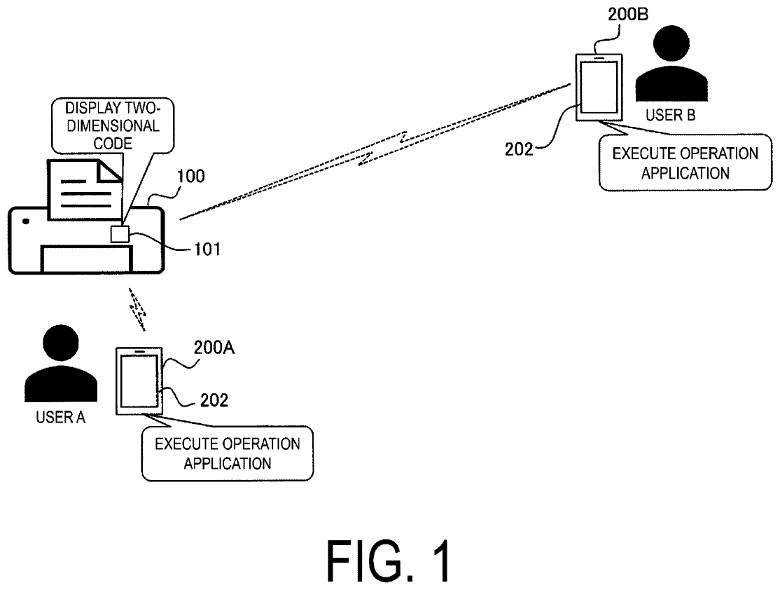

FIG. 1 is a diagram illustrating a configuration example of an image processing system according to the present embodiment. The image processing apparatus 100 includes an image processing apparatus 100 and a plurality of wireless communication terminals 200 (200A, 200B). In FIG. 1, two wireless communication terminals 200A of the user A and 200B of the user B are illustrated as the wireless communication terminals 200, but the image processing system may include one or three or more wireless communication terminals 200.

The image processing apparatus 100 is an apparatus that executes image processing including printing and/or scanning. The image processing apparatus 100 may be a printer, a copier, a scanner, a fax machine, or a multifunction printer having these functions. In the present embodiment, the image processing apparatus 100 has a function of performing wireless communication. The image processing apparatus 100 includes a display 101 that displays an image including various types of information.

Each wireless communication terminal 200 is an apparatus that performs wireless communication. The wireless communication terminal 200 may be a mobile terminal, for example, a smartphone, a tablet terminal, a laptop computer (PC), or the like. The wireless communication wireless communication terminal 200 moves along with movement of the user.

A display 101 of the image processing apparatus 100 is lower in resolution, lower in refresh rate, and/or smaller in size than a display 202 of the wireless communication terminal 200. In the present embodiment, the image processing apparatus 100 includes the display 101 that is as small as possible to display a two-dimensional code. The two-dimensional code is, for example, a QR code (trade name). The display 101 of the image processing apparatus 100 includes a substantially square window along an outer peripheral shape of the two-dimensional code. The present embodiment mainly describes an example in which the code displayed by the image processing apparatus 100 (display 101) is a two-dimensional code. However, the code displayed by the image processing apparatus 100 (display 101) may be a one-dimensional code (for example, a barcode).

Each wireless communication terminal 200 executes an operation application for operating the image processing apparatus 100. The wireless communication terminal 200 that executes the operation application causes the display 202 to display thereon an operation screen of the image processing apparatus 100. The operation screen includes a connection screen used upon establishment of a connection to the image processing apparatus 100, and a menu screen used after the establishment of the connection to the image processing apparatus 100. On the menu screen, an operation button for instructing to perform image processing may be displayed for each type of image processing.

Each wireless communication terminal 200 may operate the image processing apparatus 100 through wireless communication with the image processing apparatus 100. In the present embodiment, each wireless communication terminal 200 establishes a direct wireless communication connection to the image processing apparatus 100 to perform direct wireless communication with the image processing apparatus 100. Such direct wireless communication may be an ad hoc mode (also referred to as an “access point mode”) of a wireless Local Area

Network (LAN) communication scheme. In this case, the image processing apparatus 100 functions as a wireless LAN access point. The wireless LAN communication scheme may be a scheme conforming to the IEEE 802.11 standards. Alternatively, the direct wireless communication may be wireless communication of a Bluetooth (trade name) scheme. Hereinafter, an example is mainly described in which the ad hoc mode of the wireless LAN communication scheme is used for the direct wireless communication between the image processing apparatus 100 and each wireless communication terminal 200.

In this way, the image processing apparatus 100 can establish wireless communication connections to the plurality of wireless communication terminals 200. Accordingly, the image processing apparatus 100 can receive image processing instructions from the plurality of wireless communication terminals 200 at the same time. For example, a case is assumed in which after the user A of the wireless communication terminal 200A sets a document or paper on the image processing apparatus 100, the wireless communication terminal 200A transmits an image processing instruction to the image processing apparatus 100. Here, before the wireless communication terminal 200A transmits the image processing instruction to the image processing apparatus 100, the wireless communication terminal 200B may transmit an image processing instruction (for example, a scanning instruction, a fax instruction, or a printing instruction) to the image processing apparatus 100.

In such a case, the image processing apparatus 100 executes image processing corresponding to the image processing instruction from the wireless communication terminal 200B, that is, image processing not intended by the user A who has set the document or the paper. As a result, the user A may suffer disadvantage.

For example, it is assumed that immediately after the user A sets a document on a document table of the image processing apparatus 100, the user B performs a scan execution operation and the wireless communication terminal 200B transmits a scanning instruction to the image processing apparatus 100. In this case, the image processing apparatus 100 may scan the document and transmit a scan result (image date) to the wireless communication terminals 200B. Accordingly, the content of the document set by the user A is known to the user B.

Alternatively, it is assumed that immediately after the user A sets a document on the document table of the image processing apparatus 100, the user B performs a fax execution operation and the wireless communication terminal 200B transmits a fax instruction to the image processing apparatus 100. In this case, the image processing apparatus 100 may fax the document to the unintended party. Accordingly, the content of the document set by the user A is known to the unintended party.

Alternatively, it is assumed that immediately after the user A sets paper of the user A in the image processing apparatus 100, the user B performs a print execution operation and the wireless communication terminal 200B transmits a printing instruction to the image processing apparatus 100. In this case, the image processing apparatus 100 performs printing on the paper of the user A, and the paper of the user A is consumed.

Thus, in the present embodiment, particularly when the image processing apparatus

100 is in wireless communication with the plurality of wireless communication terminals 200, priority of image processing can be given to the user A in the vicinity of the image processing apparatus 100. For the user B who is at a position away from the image processing apparatus 100, the image processing apparatus 100 performs priority control of suspending or refraining from receiving the image processing instruction, enabling the problem as described above to be solved. A mode in which such control is performed is referred to as a “first mode”, and a mode in which such control is not performed is referred to as a “second mode”. The first mode will mainly be described below.

Specifically, first, the image processing apparatus 100 presents authentication information (also referred to as “first authentication information”) that the wireless communication terminal 200 can acquire. Here, the image processing apparatus 100 presents the authentication information in such a manner that the wireless communication terminal 200A approaching the image processing apparatus 100 can directly acquire the authentication information from the image processing apparatus 100. In the present embodiment, the image processing apparatus 100 performs the presentation by causing the display 101 to display a two-dimensional code obtained by encoding the authentication information.

Second, the wireless communication terminal 200A acquires authentication information presented by the image processing apparatus 100. In the present embodiment, the wireless communication terminal 200A acquires the authentication information by imaging a two-dimensional code obtained by encoding the authentication information.

Third, the wireless communication terminal 200A transmits, to the image processing apparatus 100 through wireless communication with the image processing apparatus 100, the acquired authentication information (also referred to as “second authentication information”) and an image processing instruction instructing execution of image processing. The second authentication information may be the same authentication information as the first authentication information or may be authentication information changed in accordance with a rule shared with the image processing apparatus 100 in advance. The image processing apparatus 100 receives, from the wireless communication terminal 200A through wireless communication with the wireless communication terminal 200A, the image processing instruction instructing execution of the image processing and the second authentication information associated with the image processing instruction. The “second authentication information associated with the image processing instruction” may be authentication information transmitted from the same transmission source as that of the image processing instruction or may be authentication information transmitted at the same timing as the image processing instruction.

Fourth, the image processing apparatus 100 performs authentication processing to check whether the received authentication information (second authentication information) matches the authentication information (first authentication information) presented by the image processing apparatus 100. “Checking whether the received authentication information matches the presented authentication information” may be checking whether the second authentication information matches the first authentication information, or may be checking whether the second authentication information is obtained by changing the first authentication information in accordance with a rule.

Fifth, based on success in the authentication processing, the image processing apparatus 100 executes image processing corresponding to the received image processing instruction. On the other hand, when the authentication processing fails, the image processing apparatus 100 does not execute the image processing corresponding to the received image processing instruction.

Such an operation enables the problem as described above to be solved. Thus, the convenience of the user utilizing the image processing apparatus 100 can be further improved.

### Configuration Example of Image Processing Apparatus

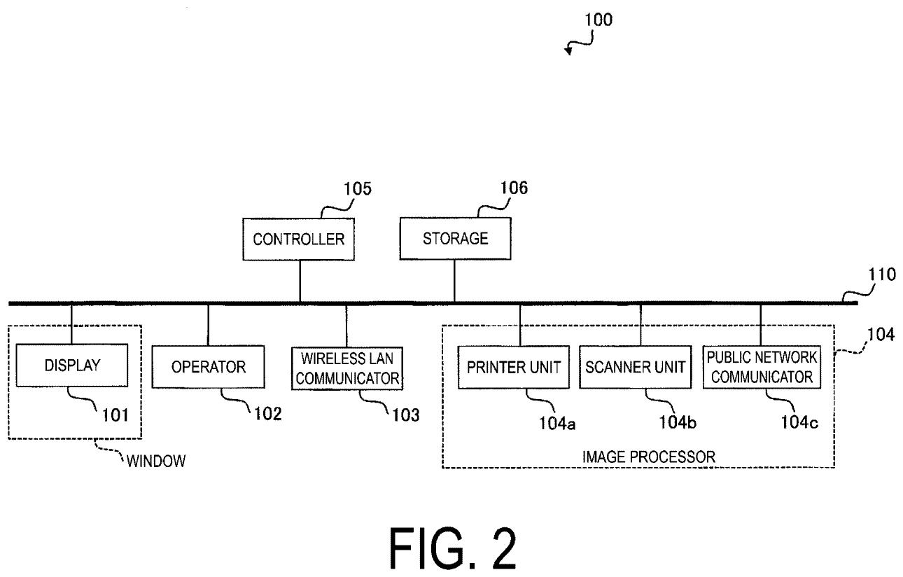

FIG. 2 is a diagram illustrating a configuration example of the image processing apparatus 100 according to the present embodiment.

The image processing apparatus 100 includes the display 101, an operator 102, a wireless LAN communicator 103, an image processor 104, a controller 105, and a storage 106. The display 101, the operator 102, the wireless LAN communicator 103, the image processor 104, the controller 105, and the storage 106 are electrically connected to one another through a bus 110, for example. In the illustrated example, all of the components are schematically connected to one bus 110, but a plurality of buses, for example, an address bus, a data bus, and a control bus, may be provided. An interface may be interposed between the bus 110 and each component. Note that at least a portion of the operator 102 that receives a user operation (user input) may be integrated with the display 101 that displays an image to constitute a touch panel display.

The display 101 includes a liquid crystal display or an organic Electro Luminescence (EL) display. These displays include a relatively large number of pixels regularly arranged, and can display an image including an arbitrary shape based on image data. The display 101 may be capable of displaying a color image, may be capable of displaying only a grayscale image (and a monochrome image), or may be capable of displaying only a monochrome image (a binary image). In the present embodiment, the display 101 constitutes a window for displaying a two-dimensional code. The window (display 101) has a substantially square shape along the outer peripheral shape of the two-dimensional code.

In the present embodiment, the display 101 constitutes a presentation unit that presents authentication information (first authentication information) that the wireless communication terminal 200 can acquire. The authentication information may be a password including a combination of characters (including numbers) and/or symbols. The authentication information may be a one-time password having a different content for each authentication. Based on selection of the first mode, the controller 105 derives the authentication information, encodes the authentication information into a two-dimensional code, and causes the display 101 to display the two-dimensional code.

The operator 102 includes one or more physical buttons (physical keys) and/or a touch panel in the touch panel display. The touch panel may be electrostatic or pressure-sensitive. The touch panel overlapping with the display 101 detects the position of a touch operation on the display 101 and outputs a detection result. The operator 102 may include a button for designating (configuring) the first mode. The button may be a physical button (physical key) or a button (soft key) displayed by the display 101. When the button is pressed, the controller 105 may select and configure the first mode. Thus, the user can explicitly designate (configure) the first mode.

The wireless LAN communicator 103 performs wireless communication with one or more of the wireless communication terminals 200. In the present embodiment, the wireless LAN communicator 103 performs direct wireless communication with one or more wireless communication terminals 200 in an ad-hoc mode of the wireless LAN communication scheme. Such direct wireless communication is also referred to as Wi-Fi (trade name) direct. The wireless LAN communicator 103 may be considered to include only a hardware configuration (e.g., a connector, an antenna, an amplifier, a filter, and a Radio Frequency (RF) circuit), or include a software configuration in addition to the hardware configuration. Note that, instead of or in addition to the wireless LAN communicator 103, a Bluetooth (trade name) communicator may be provided that performs direct wireless communication with one or more wireless communication terminals 200.

The image processor 104 performs the image processing including printing and/or scanning. For example, the types of image processing include “printing”, “copying”, “scanning”, and “fax (facsimile)”. The type “copying” refers to a function of printing, on paper by a printer unit 104a, image data acquired by a scanner unit 104b scanning a document. The type “printing” refers to a function of printing, by the printer unit 104a, an image based on image data received by the wireless LAN communicator 103 from the wireless communication terminal 200 or an image based on data stored in a recording medium (not illustrated) connected to the image processing apparatus 100. The type “scanning” refers to a function of storing image data acquired by the scanner unit 104b scanning a document. A storage destination may be, for example, an auxiliary storage apparatus (a nonvolatile memory from another viewpoint) included in the storage 106 or a storage medium connected to the image processing apparatus 100. The type “fax” refers to a function of printing, on paper by the printer unit 104a, image data received by a public network communicator 104c from outside via a telephone line, and a function of transmitting, by the public network communicator 104c, image data acquired by the scanner unit 104b scanning a document, to outside via the telephone line. Note that the “image” may include only characters. A format of the “image data” may be various, and may be, for example, a vector format or a raster format. In the description of the present embodiment, “image” and “image data” may not be strictly distinguished from each other for the sake of convenience. The “image data” may be converted into an appropriate format in the course of the image processing. For example, the image data stored in the image processing apparatus 100 may be different in format from image data obtained upon execution of the image processing (e.g., printing or fax).

The printer unit 104a performs printing under the control of the controller 105. For example, the printer unit 104a performs printing on paper set in a sheet feed tray and discharges the printed paper to a sheet discharge tray. The printer unit 104a may include only one sheet feed tray or may include a plurality of sheet feed trays. From another viewpoint, the printer unit 104a may have a function of selecting the size of paper. The printer unit 104a may be configured to be capable of color (and monochrome and gray scale) printing, may be configured to be capable of only grayscale (and monochrome) printing, or may be configured to be capable of only monochrome printing. For example, the printer unit 104a may be an inkjet printer that performs printing by ejecting ink, a thermal printer that performs printing by heating heat-sensitive paper or an ink ribbon, or an electrophotographic printer (for example, a laser printer) that transfers toner attached to a photoreceptor irradiated with light. For example, the printer unit 104a may be a line printer in which its head has a length across a width of the paper (in a direction intersecting a conveyance direction of the paper), or may be a serial printer in which its head moves in a width direction of the paper.

The scanner unit 104b performs scanning under the control of the controller 105. The scanner unit 104b images (scans) a document set on a document table or an Auto Document Feeder (ADF) by an imaging apparatus that moves along a document glass to generate image data.

The public network communicator 104c performs image data communication via a public network under the control of the controller 105. The public network includes a telephone network and/or the Internet. The public network communicator 104c may communicate with a file server, an e-mail server, and/or a web server. The communication may be a wired communication or may include a wireless communication.

The controller 105 includes one or more processors, and controls the entire image processing apparatus 100. For example, the controller 105 executes programs stored in the storage 106 to perform various types of processing operations. In the present embodiment, the controller 105 controls the display 101, the operator 102, the wireless LAN communicator 103, the image processor 104, and the storage 106. Note that the controller 105 may include a logic circuit configured to perform only a certain operation. The operations of the image processing apparatus 100 described above and below may also be operations controlled by the controller 105.

For example, the storage 106 includes various memories such as a Read Only Memory (ROM), a Random Access Memory (RAM), and an auxiliary storage apparatus. Note that a combination of the controller 105 and the storage 106 may be considered as a computer. The program to be executed by the controller 105 is stored in the ROM and/or the auxiliary storage apparatus of the storage 106, for example.

Note that FIG. 2 is merely a schematic view. For example, a plurality of controllers 105 and storages 106 may be provided in a distributed manner. For example, a processor included in each component (a controller that controls each component from another viewpoint) and a higher layer processor (a higher layer controller that controls the controller of each component) may be provided. In such a case, the controller 105 may be considered as the higher layer controller, or may be considered as a combination of the controller of each component and the higher layer controller.

In the image processing apparatus 100 configured as described above, first, the display 101 presents the first authentication information by displaying the two-dimensional code obtained by encoding the first authentication information. Second, the wireless LAN communicator 103 receives, from the wireless communication terminal 200 through wireless communication with the wireless communication terminal 200, an image processing instruction instructing execution of image processing and second authentication information associated with the image processing instruction. Third, the controller 105 performs authentication processing to check whether the received second authentication information matches the presented first authentication information. Fourth, based on success in the authentication processing, the controller 105 controls the image processor 104 to execute image processing corresponding to the received image processing instruction.

The wireless LAN communicator 103 can execute wireless communication with a plurality of wireless communication terminals 200. After one of the plurality of wireless communication terminals 200 (in the present embodiment, the wireless communication terminal 200A) acquires the first authentication information, the controller 105 performs, for a predetermined period (also referred to as a “priority control period”), priority control of prioritizing an image processing instruction from the wireless communication terminal 200A over image processing instructions from the different wireless communication terminal 200B. In the present embodiment, the controller 105 can recognize that the wireless communication terminal 200A has acquired the first authentication information through wireless communication with the wireless communication terminal 200A.

For example, as a first pattern of the priority control, the controller 105 performs control of not receiving the image processing instruction from the wireless communication terminals 200B for the priority control period. When the wireless LAN communicator 103 receives the image processing instruction from the wireless communication terminal 200B within the priority control period, the controller 105 may reject the image processing instruction. In this case, the controller 105 may control the wireless LAN communicator 103 to transmit the rejection to the wireless communication terminal 200B.

Alternatively, as a second pattern of the priority control, the controller 105 performs control of suspending the image processing instruction until the priority control period elapses while receiving the image processing instruction from the wireless communication terminal 200B. When the wireless LAN communicator 103 receives an image processing instruction from the wireless communication terminal 200B during the priority control period, the controller 105 may temporarily store the image processing instruction in the storage 106. When the priority control period elapses, the controller 105 reads out the stored image processing instruction and controls the image processor 104 to execute image processing corresponding to the image processing instruction.

The priority control period may be a period until completion of image processing (image processing job) corresponding to the image processing instruction from the wireless communication terminals 200A. The controller 105 may end the priority control in response to the completion. That is, the priority control period may be a variable period whose time length can be varied in accordance with the content of the image processing instruction from the wireless communication terminals 200A. The controller 105 can configure a priority control period having an appropriate time length in accordance with the type of image processing.

Alternatively, the priority control period may have a fixed time length. In this case, the controller 105 sets a priority control period having a fixed time length regardless of the type of image processing.

When performing priority control of prioritizing the wireless communication terminal 200A, the controller 105 may control the wireless LAN communicator 103 to transmit, to the wireless communication terminal 200B, a notification related to the priority control. In the case of the first pattern of the priority control, the wireless LAN communicator 103 transmits, to the wireless communication terminal 200B, a notification indicating that the image processing instruction from the wireless communication terminal 200B is not received for the priority control period. The wireless communication terminal 200B displays the notification. On the other hand, in the case of the second pattern of the priority control, the wireless LAN communicator 103 transmits, to the wireless communication terminal 200B, a notification indicating that the image processing instruction from the wireless communication terminal 200B is suspended until the priority control period elapses. The wireless communication terminal 200B displays the notification.

The controller 105 may identify the user A of the wireless communication terminal 200A. For example, based on the wireless communication with the wireless communication terminal 200A, the controller 105 may acquire identification information of the user A upon establishment of a wireless communication connection to the wireless communication terminal 200A, or may acquire the identification information of the user A upon reception of the image processing instruction from the wireless communication terminal 200A. The controller 105 may control the wireless LAN communicator 103 to transmit, to the wireless communication terminal 200B, a notification including information (identification information) of the identified user A. The wireless communication terminal 200B displays the identification information. For example, in the case of the first pattern of the priority control, the wireless communication terminal 200B displays a message “The image processing job of the user A is in execution. Your image processing job is now not received.” is displayed to the user B. On the other hand, in the case of the second pattern of the priority control, the wireless communication terminal 200B displays a message “The image processing job of the user A is in execution. Your image processing job will be executed after the end of image processing job of the user A.” is displayed to user B.

The controller 105 selects and configures one of the first mode in which the image processing corresponding to the image processing instruction is executed on condition that the authentication processing is successful and the second mode in which the image processing corresponding to the image processing instruction is executed without executing the authentication processing. The second mode is a mode in which an operation same as, and/or similar to a known operation is performed. In the first mode, although the above-described problem can be solved, the user A needs to read the two-dimensional code, increasing time and effort required for the user A. Accordingly, the convenience can further be improved by allowing one of the first mode and the second mode to be selected.

Based on the selection of the first mode, the controller 105 may control the wireless LAN communicator 103 to transmit, to each of the wireless communication terminals 200 (the wireless communication terminals 200A and 200B), a notification indicating that the first mode is selected. Thus, the users (user A and user B) of the wireless communication terminals 200 can recognize the need to read the two-dimensional code in order to execute the image processing.

The controller 105 may select the first mode based on the wireless LAN communicator 103 being in wireless communication with a plurality of wireless communication terminals 200. On the other hand, the controller 105 may select the second mode based on the wireless LAN communicator 103 being in wireless communication with only one wireless communication terminal 200. When the wireless LAN communicator 103 is in wireless communication with the only one wireless communication terminal 200, the above-described problem does not occur. Accordingly, the controller 105 may recognize the number of wireless communication connections currently established by the wireless LAN communicator 103 and select the first mode only when the wireless LAN communicator 103 is in wireless communication with a plurality of wireless communication terminals 200.

The controller 105 may select the first mode based on the operator 102 receiving a predetermined operation of designating the first mode. As described above, the operator 102 may include a button for designating (configuring) the first mode. The button may be a physical button (physical key) or a button (soft key) displayed by the display 101. When the button is pressed (that is, when a predetermined operation is performed), the controller 105 selects and configures the first mode. Thus, the user can explicitly designate the first mode. On the other hand, the controller 105 selects the second mode based on the operator 102 not receiving the predetermined operation.

The controller 105 may select the first mode based on the wireless LAN communicator 103 receiving, through wireless communication, a predetermined signal designating the first mode. For example, when the user A operates the first mode configuration button displayed on the wireless communication terminal 200A, the wireless communication terminal 200A transmits, to the image processing apparatus 100, a predetermined signal (command) for configuring the first mode. Thus, the user can explicitly designate the first mode. On the other hand, the controller 105 may select the second mode based on the wireless LAN communicator 103 not receiving the predetermined signal.

Based on the selection of the first mode, the controller 105 may control the display 101 to display a two-dimensional code obtained by encoding authentication information (first authentication information). The controller 105 may cause the display 101 to display the two-dimensional code at the timing of selection of the first mode, or may cause the display 101 to display the two-dimensional code at a timing when a document or paper is set in the image processing apparatus 100 after the selection of the first mode. On the other hand, based on the selection of the second mode, the controller 105 may control the display 101 to refrain from displaying the two-dimensional code obtained by encoding the authentication information (first authentication information).

### Configuration Example of Wireless Communication Terminal

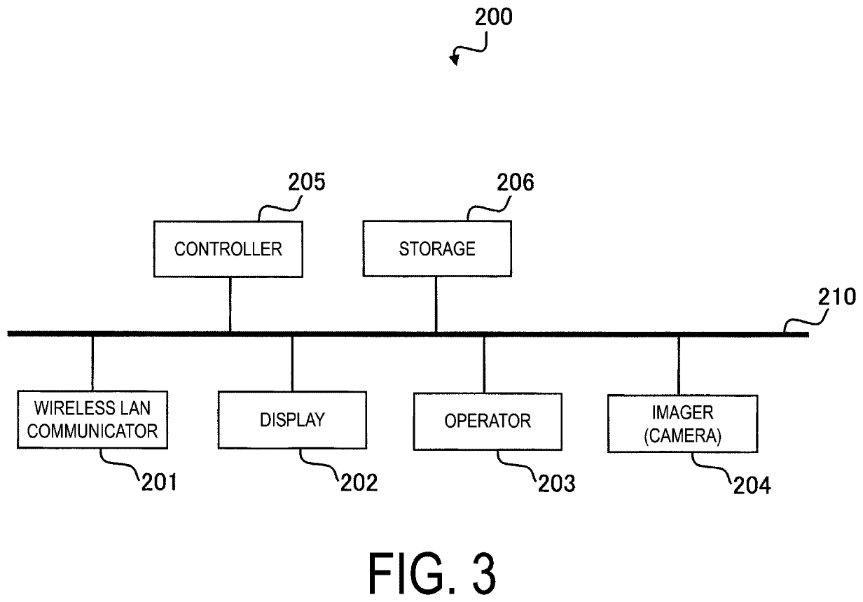

FIG. 3 is a diagram illustrating a configuration example of the wireless communication terminal 200 according to the present embodiment. Here, a description of a configuration the same as and/or similar to the above-described configuration is omitted as appropriate.

The wireless communication terminal 200 includes a wireless LAN communicator 201, a display 202, an operator 203, an imager 204, a controller 205, and a storage 206. The wireless LAN communicator 201, the display 202, the operator 203, the imager 204, the controller 205, and the storage 206 are electrically connected to one another through a bus 210, for example.

The wireless LAN communicator 201 performs wireless communication with the image processing apparatus 100. In the present embodiment, the wireless LAN communicator 201 may perform direct wireless communication with the image processing apparatus 100 in the ad hoc mode of the wireless LAN communication scheme. Instead of or in addition to the wireless LAN communicator 201, a Bluetooth (trade name) communicator may be provided that performs direct wireless communication with one or more wireless communication terminals 200. Note that the wireless communication terminal 200 may further include a public network communicator that performs communication via a public network. The public network may include a cellular communication network. The public network communicator may be a cellular communicator.

The display 202 displays an image under control of the controller 205. The operator 203 receives user operation (user input). At least a portion of the operator 203 may be integrated with the display 202 to configure a touch panel display. At least a portion of the operator 203 may be configured as one or more physical buttons. The display 202 includes a liquid crystal display or an organic EL display. The operator 203 detects the position of a touch operation on the display 202, and outputs a detection result.

The imager 204 constitutes a camera including an image sensor, such as a Charge Coupled Device (CCD) or a Complementary Metal Oxide Semiconductor (CMOS). The imager 204 electronically captures an image under control of the controller 205, and outputs image data.

The controller 205 includes one or more processors, and controls the entire wireless communication terminal 200. The controller 205 executes various types of processing operations by executing a control program stored in the storage 206. The program may include an operation application for operating the image processing apparatus 100. The controller 205 controls operation of each of the wireless LAN communicator 201, the display 202, the operator 203, the imager 204, the controller 205, and the storage 206. Note that the controller 205 may include a logic circuit configured to perform only a certain operation. The operations of the wireless communication terminal 200 described above and below may also be operations controlled by the controller 205.

For example, the storage 206 includes various memories such as a ROM, a RAM, and an auxiliary storage apparatus. Note that a combination of the controller 205 and the storage 206 may be considered as a computer. The program to be executed by the controller 205 is stored in the ROM and/or the auxiliary storage apparatus of the storage 206, for example.

In the wireless communication terminal 200 configured as described above, the imager 204 acquires, by imaging, authentication information (two-dimensional code) displayed by the image processing apparatus 100. That is, in the present embodiment, the imager 204 constitutes an acquiring unit for acquiring the authentication information presented by the image processing apparatus 100. The controller 205 controls the wireless LAN communicator 201 to transmit, to the image processing apparatus 100, the acquired authentication information and an image processing instruction instructing execution of image processing. In the present embodiment, the wireless LAN communicator 201 transmits the authentication information obtained by decoding the two-dimensional code imaged by the imager 204, to the image processing apparatus 100 together with the image processing instruction.

The wireless LAN communicator 201 may receive, from the image processing apparatus 100, a notification indicating that the image processing apparatus 100 has selected the first mode. As described above, the first mode is a mode in which the image processing apparatus 100 executes the image processing corresponding to the image processing instruction on the condition of success in the authentication processing of checking whether the authentication information presented by the image processing apparatus 100 matches the authentication information transmitted by the wireless communication terminal 200. Based on the notification, the controller 205 may cause the display 202 to display a screen prompting the user to acquire the authentication information presented by the image processing apparatus 100. For example, in response to the reception of the notification, the controller 205 may cause the display 202 to display text such as “Execution of the image processing job requires imaging of the two-dimensional code displayed on the image processing apparatus”.

### System Operation Example

An operation example of the image processing system according to the present embodiment will be described.

### (1) First Operation Example

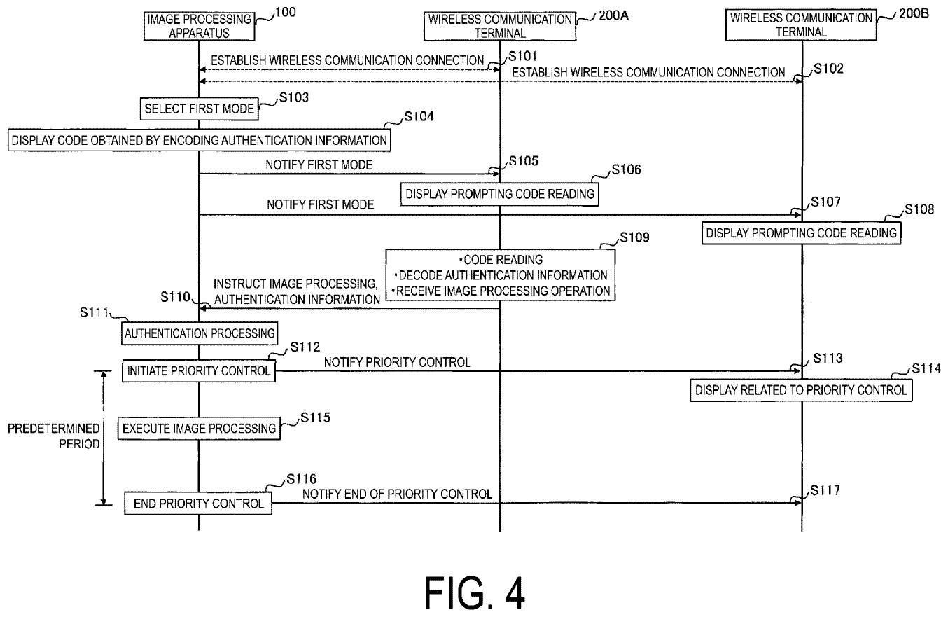

FIG. 4 is a diagram illustrating a first operation example of an image processing system according to the present embodiment.

In step S101, the wireless communication terminal 200A establishes a wireless communication connection to the image processing apparatus 100. In step S102, the wireless communication terminal 200B establishes a wireless communication connection to the image processing apparatus 100. Note that the order of step S101 and step S102 may be reversed. In step S103, the image processing apparatus 100 selects the first mode. The image

processing apparatus 100 may select the first mode based on the image processing apparatus 100 having established wireless communication connections to the plurality of wireless communication terminals 200. The image processing apparatus 100 may select the first mode based on the operator 102 receiving a predetermined operation of designating the first mode. The image processing apparatus 100 may select the first mode based on the image processing apparatus 100 receiving, through wireless communication, a predetermined signal designating the first mode.

In step S104, based on the selection of the first mode, the image processing apparatus 100 displays the two-dimensional code obtained by encoding the authentication information (first authentication information).

In step S105, the image processing apparatus 100 transmits, to the wireless communication terminal 200A, a notification indicating that the image processing apparatus 100 is in the first mode. In step S106, based on the notification, the wireless communication terminal 200A displays a message prompting the user A to read the two-dimensional code.

In step S107, the image processing apparatus 100 transmits a notification indicating that the image processing apparatus 100 is in the first mode to the wireless communication terminal 200B. In step S108, based on the notification, the wireless communication terminal 200B displays a message prompting the user B to read the two-dimensional code.

Each wireless communication terminal 200 may perform display for prompting reading of the two-dimensional code immediately after receiving the notification indicating that the wireless communication terminal 200 is in the first mode. Alternatively, after receiving the notification, each wireless communication terminal 200 may perform display for prompting reading of the two-dimensional code when the user operates a menu screen for configuring and instructing image processing.

In step S109, the wireless communication terminal 200A images the two-dimensional code displayed on the image processing apparatus 100 and decodes the authentication information from the two-dimensional code. The wireless communication terminal 200A receives, from the user A, an operation of instructing execution of image processing. Here, after displaying an imaging screen for imaging the two-dimensional code, the wireless communication terminal 200A may switch the display to a screen for receiving an operation of instructing execution of image processing; the switching is triggered by the imaging of the two-dimensional code.

In step S110, the wireless communication terminal 200A transmits, to the image processing apparatus 100, a set of the image processing instruction instructing execution of the image processing and the decoded authentication information. The image processing apparatus 100 receives the set.

In step S111, the image processing apparatus 100 performs authentication processing of checking whether the authentication information presented in step S104 matches the authentication information received in step S110. When these pieces of authentication information are confirmed to be matched, the image processing apparatus 100 determines that the authentication is successful. Here, the description below is based on the assumption that the authentication processing is successful.

When the authentication information presented in step S104 and the authentication information received in step S110 do not match, the image processing apparatus 100 may determine that the authentication has failed and reject the image processing instruction received in step S110. In this case, the image processing apparatus 100 may transmit a notification indicating that the image processing apparatus 100 has rejected the image processing instruction, to the wireless communication terminal 200 that is the transmission source of the image processing instruction.

When, in the first mode, the image processing apparatus 100 receives, from one of the wireless communication terminals 200, an image processing instruction to which no authentication information is attached, the image processing apparatus 100 may reject the image processing instruction. In this case, the image processing apparatus 100 may transmit a notification indicating that the image processing apparatus 100 has rejected the image processing instruction, to the wireless communication terminal 200 that is the transmission source of the image processing instruction.

In step S112, in response to the success in the authentication processing, the image processing apparatus 100 initiates priority control of prioritizing the image processing instruction from the wireless communication terminal 200A over the image processing instruction from the wireless communication terminal 200B. For example, as a first pattern of the priority control, the image processing apparatus 100 performs control of not receiving the image processing instruction from the wireless communication terminals 200B for a priority control period. Alternatively, as a second pattern of the priority control, the image processing apparatus 100 performs control of suspending the image processing instruction until the priority control period elapses while receiving the image processing instruction from the wireless communication terminal 200B.

The priority control period may be a period until completion of image processing (image processing job) corresponding to the image processing instruction from the wireless communication terminals 200A. The image processing apparatus 100 may end the priority control in response to the completion (step S116). Alternatively, the priority control period may have a fixed time length. In this case, regardless of the type of image processing, the image processing apparatus 100 ends the priority control when the priority control period having the fixed time length elapses (step S116).

In step S113, the image processing apparatus 100 transmits, to the wireless communication terminal 200A, a notification regarding the priority control of prioritizing the wireless communication terminal 200B. In the case of the first pattern of the priority control, the image processing apparatus 100 may transmit, to the wireless communication terminal 200B, a notification indicating that the image processing instruction from the wireless communication terminal 200B is not received for the priority control period. In the case of the second pattern of the priority control, the image processing apparatus 100 transmits, to the wireless communication terminal 200B, a notification indicating that the image processing instruction from the wireless communication terminal 200B is suspended until the priority control period elapses. In step S114, the wireless communication terminal 200B displays the notification.

Here, the image processing apparatus 100 may identify the user A of the wireless communication terminal 200A and transmit, to the wireless communication terminal 200B, a notification including information (identification information) of the identified user A (step S113). The wireless communication terminal 200B may display the identification information (step S114).

In step S115, the image processing apparatus 100 executes image processing (image processing job) corresponding to the image processing instruction received in step S110. The image processing may be, for example, any one of “copying”, “scanning”, and “fax”.

In step S116, the image processing apparatus 100 ends the priority control in response to the elapse of the priority control period. In step S117, the image processing apparatus 100 transmits, to the wireless communication terminal 200B, a notification indicating that the priority control is to be ended. The wireless communication terminal 200B displays the notification.

### (2) Second Operation Example

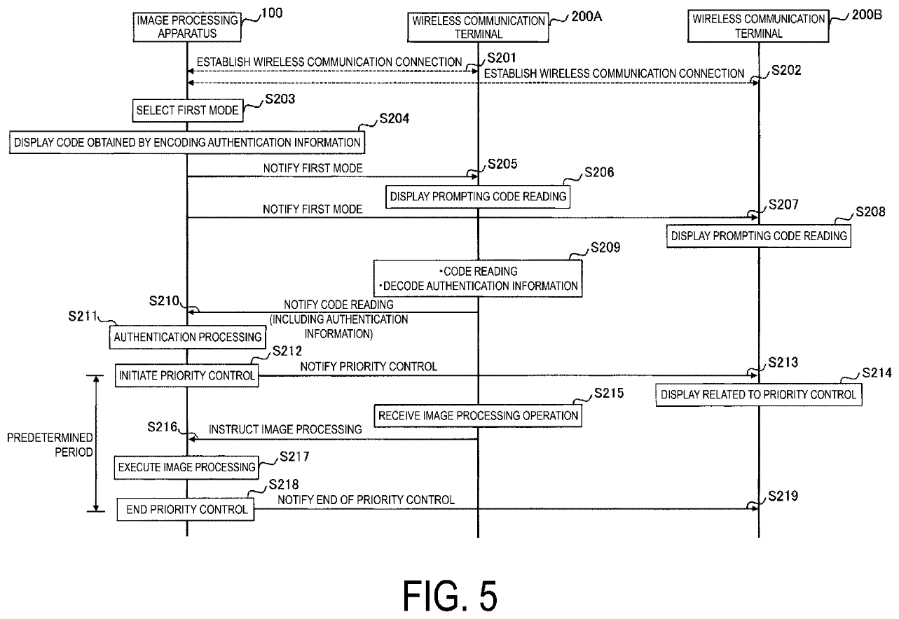

FIG. 5 is a diagram illustrating a second operation example of the image processing system according to the present embodiment. Here, differences from the first operation example described above will be described, and overlapping description will be omitted.

The operations in step S201 to step S208 are the same as and/or similar to those of the first operation example described above.

In step S209, the wireless communication terminal 200A images the two-dimensional code displayed on the image processing apparatus 100 and decodes the authentication information from the two-dimensional code.

In step S210, the wireless communication terminal 200A transmits, to the image processing apparatus 100, a notification including the authentication information decoded in step S209. The image processing apparatus 100 receives the notification and stores the wireless communication terminal 200A as a transmission source of the notification. In this operation example, the authentication information may not need to be transmitted together with the image processing instruction as a set.

In step S211, the image processing apparatus 100 performs authentication processing to check whether the authentication information presented in step S204 matches the authentication information received in step S210. When these pieces of authentication information are confirmed to be matched, the image processing apparatus 100 determines that the authentication is successful. Here, the description below is based on the assumption that the authentication processing is successful. In response to the determination of the successful authentication, the image processing apparatus 100 may transmit, to the wireless communication terminal 200A, a notification indicating successful authentication (authentication OK). In response to reception of the notification, the wireless communication terminal 200A may display to the user A that the authentication processing is successful.

When the authentication information presented in step S204 does not match the authentication information received in step S210, the image processing apparatus 100 may determine that the authentication has failed and reject the image processing instruction received in step S210. In this case, the image processing apparatus 100 may transmit a notification indicating that the image processing apparatus 100 has rejected the image processing instruction, to the wireless communication terminal 200 that is the transmission source of the image processing instruction.

In step S212, in response to the success in the authentication processing, the image processing apparatus 100 initiates the priority control of prioritizing the image processing instruction from the wireless communication terminal 200A over the image processing instruction from the wireless communication terminal 200B. In step S213, the image processing apparatus 100 transmits, to the wireless communication terminal 200A, a notification regarding the priority control of prioritizing the wireless communication terminal 200B. In step S214, the wireless communication terminal 200B displays the notification. The image processing apparatus 100 may identify the user A of the wireless communication terminal 200A and transmit, to the wireless communication terminal 200B, a notification including information (identification information) of the identified user A (step S213). The wireless communication terminal 200B may display the identification information (step S214).

In step S215, the wireless communication terminal 200A receives, from the user A, an operation of instructing execution of the image processing.

In step S216, the wireless communication terminal 200A transmits, to the image processing apparatus 100, an image processing instruction instructing execution of image processing. The image processing apparatus 100 receives the image processing instruction. The image processing apparatus 100 confirms that the image processing instruction has come from the wireless communication terminal 200A that has succeeded in the authentication processing. In step S217, the image processing apparatus 100 executes image processing (image processing job) corresponding to the image processing instruction received in step S216.

In step S218, the image processing apparatus 100 ends the priority control in response to the elapse of the priority control period. In step S219, the image processing apparatus 100 transmits, to the wireless communication terminal 200B, a notification indicating that the priority control is to be ended. The wireless communication terminal 200B displays the notification.

### First Variation

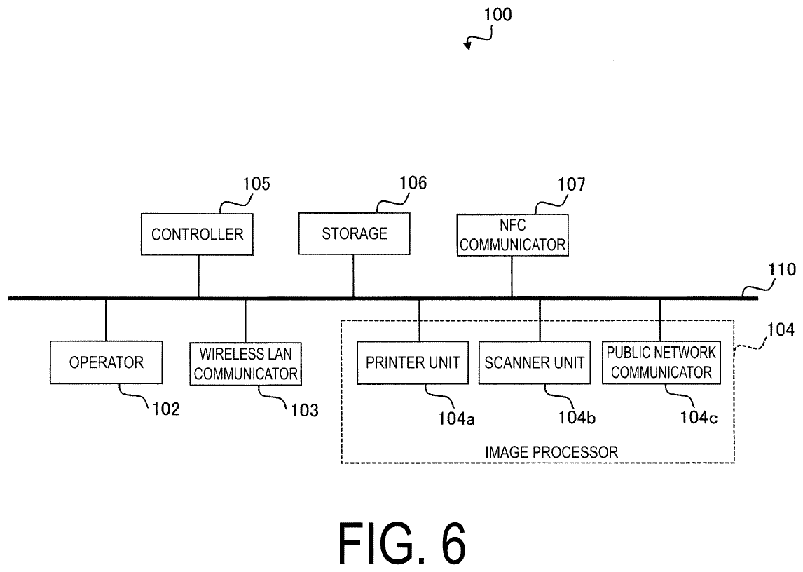

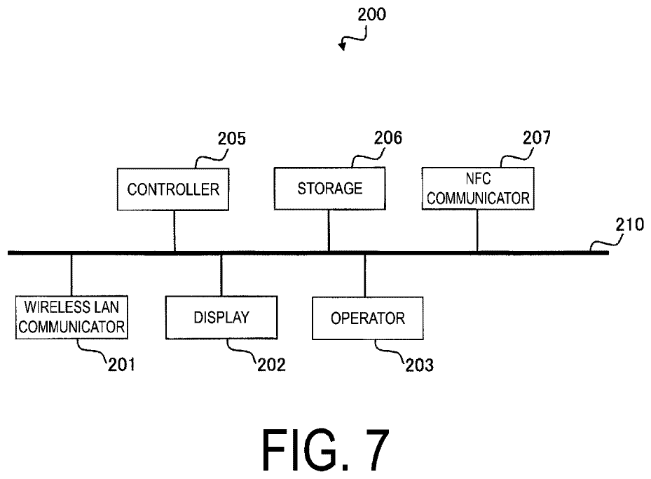

FIG. 6 is a diagram illustrating a variation of the image processing apparatus 100 according to the above-described embodiment. FIG. 7 is a diagram illustrating a variation of the wireless communication terminal 200 according to the above-described embodiment.

In the above-described embodiment, the image processing apparatus 100 presents the authentication information by displaying the two-dimensional code obtained by encoding the authentication information. The wireless communication terminal 200 acquires the authentication information by imaging (and decoding) the two-dimensional code displayed by the image processing apparatus 100. That is, in the above-described embodiment, the image processing apparatus 100 is assumed to include the display 101 (specifically, a window unit) that displays an image.

In the present variation, as illustrated in FIG. 6, the image processing apparatus 100 may not need to include the display 101. According to the present variation, the image processing apparatus 100 includes a Near Field Communication (NFC) communicator 107 that performs NFC communication. The NFC communicator 107 constitutes a presentation unit that presents authentication information by transmitting the authentication information through NFC communication.

In the present variation, as illustrated in FIG. 7, the wireless communication terminal 200 may not need to include the imager 204 that captures an image. According to the present variation, the wireless communication terminal 200 includes an NFC communicator 207 that performs NFC communication. The NFC communicator 207 constitutes an acquiring unit that acquires authentication information by receiving the authentication information through NFC communication.

The NFC communication is, for example, a wireless communication technology with a communication distance of approximately 10 cm using a frequency of 13.56 MHz. When the user holds the wireless communication terminal 200 over the image processing apparatus 100, the wireless communication terminal 200 and the image processing apparatus 100 engage in NFC communication.

In the present embodiment, since NFC is used instead of the two-dimensional code, the code reading (two-dimensional code reading) in the above-described embodiment is read as NFC reading.

### Second Variation

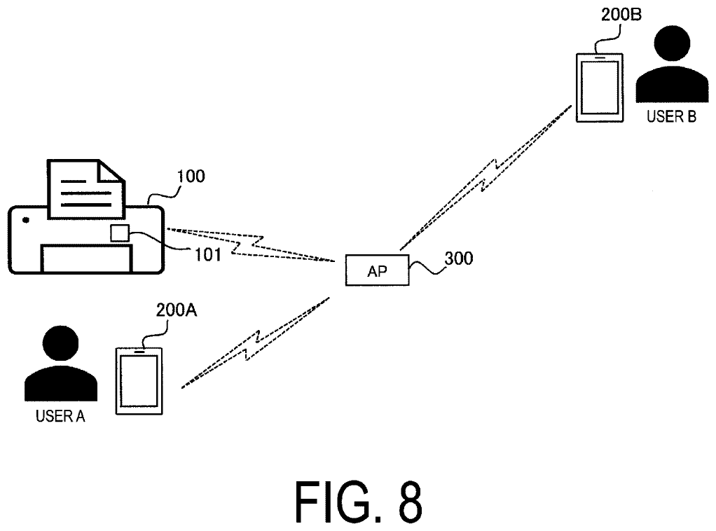

FIG. 8 is a diagram illustrating a configuration example of the image processing system according to the above-described embodiment. The image processing apparatus 100 includes the display 101 in the illustrated example, but may be provided with the NFC communicator 107 instead of the display 101 as in the above-described first variation.

In the example described above in the embodiment, the wireless communication between the image processing apparatus 100 and the wireless communication terminal 200 is direct wireless communication. In contrast, in the present variation, the wireless communication between the image processing apparatus 100 and the wireless communication terminal 200 is indirect wireless communication via an access point (AP) 300. The AP 300 is also referred to as a wireless LAN router.

For example, in the present variation, an infrastructure mode of the wireless LAN communication scheme is used as wireless communication between the image processing apparatus 100 and the wireless communication terminal 200. Each of the wireless communication terminals 200 accesses the image processing apparatus 100 via the AP 300 and establishes a wireless communication connection to the image processing apparatus 100 via the AP 300.

### OTHER EMBODIMENTS

In the above-described embodiment, the “printing” may include 3D printing. That is, the image processing apparatus 100 may have a function of 3D printing. For example, the printer unit 104a may be a 3D printer that forms a three-dimensional object using resin and/or metallic powder.

The operational flow of the embodiment described above need not necessarily be executed in chronological order according to the order described in the flow diagram. For example, the steps of operation may be performed in a different order from that described in the flow diagram or may be performed in parallel. Some steps of operation may be omitted and additional steps may be added to the process.

A program that causes the computer (the image processing apparatus 100, the wireless communication terminal 200) to perform operations according to the embodiments described above may be provided. The program may be recorded in a computer readable medium. Use of the computer readable medium enables the program to be installed on a computer (an information processing apparatus). Here, the computer readable medium on which the program is recorded may be a non-transitory recording medium. The non-transitory recording medium is not particularly limited, and may be, for example, a recording medium such as a CD-ROM or a DVD-ROM.

The phrases “based on” and “depending on/in response to” used in the present disclosure do not mean “based only on” and “only depending on/in response to,” unless specifically stated otherwise. The phrase “based on” means both “based only on” and “based at least in part on”. The phrase “depending on” means both “only depending on” and “at least partially depending on”. The terms “include”, “comprise”, and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### Supplementary Note

Features relating to the embodiments described above are described below as supplements.

### Supplementary Note 1

An image processing apparatus (100) including:
an image processor (104) configured to execute image processing including printing and/or scanning;
a presentation unit (101, 107) configured to present first authentication information that can be acquired by a wireless communication terminal (200);
a communicator (103) configured to receive, from the wireless communication terminal (200) through wireless communication with the wireless communication terminal (200), an image processing instruction instructing execution of the image processing and second authentication information associated with the image processing instruction; and
a controller (105) configured to perform authentication processing of checking whether the received second authentication information matches the presented first authentication information, in which
the controller (105) controls, based on success in the authentication processing, the image processor (104) to execute the image processing corresponding to the received image processing instruction.

### Supplementary Note 2

The image processing apparatus (100) according to Supplementary Note 1, in which the communicator (103) can execute wireless communication with a plurality of wireless communication terminals (200A, 200B) including the wireless communication terminal (200A), and
the controller (105) performs, after the wireless communication terminal (200A) acquires the first authentication information, priority control of prioritizing the image processing instruction from the wireless communication terminal (200A) over an image processing instruction from a different wireless communication terminal (200B) for a predetermined period.

### Supplementary Note 3

The image processing apparatus (100) according to Supplementary Note 2, in which the controller (105) performs, as the priority control, control of not receiving the image processing instruction from the different wireless communication terminal (200B).

### Supplementary Note 4

The image processing apparatus (100) according to Supplementary Note 2, in which the controller (105) performs, as the priority control, control of receiving the image processing instruction from the different wireless communication terminal (200B) and suspending the image processing instruction from the different wireless communication terminal (200B) until the predetermined period elapses.

### Supplementary Note 5

The image processing apparatus (100) according to any one of Supplementary Notes 2 to 4, in which
the predetermined period is a period until completion of the image processing corresponding to the image processing instruction from the wireless communication terminal (200), and the
controller (105) ends the priority control in response to the completion.

### Supplementary Note 6

The image processing apparatus (100) according to any one of Supplementary Notes 2 to 5, in which
the controller (105) controls, when performing the priority control, the communicator (103) to transmit a notification regarding the priority control to the different wireless communication terminal (200).

### Supplementary Note 7

The image processing apparatus (100) according to Supplementary Note 6, in which the controller (105):
identifies a user of the wireless communication terminal (200A), and controls the communicator (103) to transmit the notification including information of the identified user to the different wireless communication terminal (200B).

### Supplementary Note 8

The image processing apparatus (100) according to any one of Supplementary Notes 1 to 7, in which
the presentation unit (101, 107) presents the first authentication information in such a manner that the wireless communication terminal (200) approaching the image processing apparatus (100) is allowed to directly acquire the first authentication information from the image processing apparatus (100).

### Supplementary Note 9

The image processing apparatus (100) according to Supplementary Note 8, in which the presentation unit (101, 107) includes a display (101) configured to perform the presentation by displaying a code obtained by encoding the first authentication information and/or a Near Field Communication (NFC) communicator (107) configured to perform the presentation by transmitting the first authentication information through NFC communication.

### Supplementary Note 10

The image processing apparatus (100) according to any one of Supplementary Notes 1 to 9, in which
the controller (105) selects one of a first mode in which the image processing corresponding to the image processing instruction is executed on condition that the authentication processing is successful and a second mode in which the image processing corresponding to the image processing instruction is executed without performing the authentication processing.

### Supplementary Note 11

The image processing apparatus (100) according to Supplementary Note 10, in which the controller (105) controls, based on selection of the first mode, the communicator (103) to transmit, to the wireless communication terminal (200), a notification indicating that the first mode is selected.

### Supplementary Note 12

The image processing apparatus (100) according to Supplementary Note 10 or 11, in which the controller (105):
selects the first mode based on the communicator (103) being in wireless communication with a plurality of wireless communication terminals (200A, 200B), and
selects the second mode based on the communicator (103) being in wireless communication with only one wireless communication terminal (200).

### Supplementary Note 13

The image processing apparatus (100) according to Supplementary Note 10 or 11, further including:
an operator (102) configured to receive a user operation, in which the controller (105):
selects the first mode based on the operator (102) receiving a predetermined operation designating the first mode, and
selects the second mode based on the operator (102) not receiving the predetermined operation.

### Supplementary Note 14

The image processing apparatus (100) according to Supplementary Note 10 or 11, in which the controller (105):
selects the first mode based on the communicator (103) receiving, through wireless communication, a predetermined signal designating the first mode, and
selects the second mode based on the communicator (103) not receiving the predetermined signal.

### Supplementary Note 15

The image processing apparatus (100) according to any one of Supplementary Notes 10 to 14, in which
the controller (105):
controls, based on selection of the first mode, the presentation unit (101, 107) to present the first authentication information, and
controls, based on selection of the second mode, the presentation unit (101, 107) not to present the first authentication information.

### Supplementary Note 16

A wireless communication terminal (200) including:
a communicator (201) configured to perform wireless communication with an image processing apparatus (100) configured to execute image processing including printing and/or scanning;
an acquiring unit (204, 207) configured to acquire authentication information presented by the image processing apparatus (100); and
a controller (205) configured to control the communicator (201) to transmit, to the image processing apparatus (100) through the wireless communication, the acquired authentication information and an image processing instruction instructing execution of the image processing.

### Supplementary Note 17

The wireless communication terminal (200) according to Supplementary Note 16, further including:
a display (202), in which
the communicator (201) receives, from the image processing apparatus (100), a notification indicating that the image processing apparatus (100) has selected the first mode,
the first mode is a mode in which the image processing corresponding to the image processing instruction is executed on a condition of success in authentication processing of checking whether authentication information presented by the image processing apparatus (100) matches authentication information transmitted by the wireless communication terminal (200), and
the controller (205) causes, based on the notification, the display (202) to display a screen prompting a user to acquire authentication information presented by the image processing apparatus (100).

### Supplementary Note 18

The wireless communication terminal (200) according to Supplementary Note 16 or 17, in which
the acquiring unit (204, 207) acquires the authentication information in such a manner that the wireless communication terminal (200) approaching the image processing apparatus (100) is allowed to directly acquire the authentication information from the image processing apparatus (100).

### Supplementary Note 19

The wireless communication terminal (200) according to Supplementary Note 18, in which the acquiring unit (204, 207) includes an imager (204) configured to image a code obtained by encoding the authentication information and/or a Near Field Communication (NFC) communicator (207) configured to receive the authentication information through NFC communication.

### Supplementary Note 20

A program causing an image processing apparatus (100) configured to execute image processing including printing and/or scanning to execute:
presenting first authentication information that can be acquired by a wireless communication terminal (200);
receiving, from the wireless communication terminal (200) through wireless communication with the wireless communication terminal (200), an image processing instruction instructing execution of the image processing and second authentication information associated with the image processing instruction;
performing authentication processing of checking whether the received second authentication information matches the presented first authentication information; and
executing, based on success in the authentication processing, the image processing corresponding to the received image processing instruction.

### Supplementary Note 21

A program causing a wireless communication terminal (200) to execute:
performing wireless communication with an image processing apparatus (100) configured to execute image processing including printing and/or scanning;
acquiring authentication information presented by the image processing apparatus (100); and
transmitting, to the image processing apparatus (100) through the wireless communication with the image processing apparatus (100), the acquired authentication information and an image processing instruction instructing execution of the image processing.

### REFERENCE SIGNS

100: Image processing apparatus
101: Display
102: Operator
103: Wireless LAN communicator
104: Image processor
104a: Printer unit
104b: Scanner unit
104c: Public network communicator
105: Controller
106: Storage
107: NFC communicator
110: Bus
200: Wireless communication terminal
200A: Wireless communication terminal
200B: Wireless communication terminal
201: Wireless LAN communicator
202: Display
203: Operator
204: Imager
205: Controller
206: Storage
207: NFC communicator
210: Bus
300: AP

1. An image processing apparatus comprising:
an image processor configured to execute image processing comprising printing and/or scanning;
a presentation unit configured to present first authentication information configured to be acquired by a wireless communication terminal;
a communicator configured to receive, from the wireless communication terminal through wireless communication with the wireless communication terminal, an image processing instruction instructing execution of the image processing and second authentication information associated with the image processing instruction; and
a controller configured to perform authentication processing of checking whether the received second authentication information matches the presented first authentication information, wherein
the controller is configured to control, based on success in the authentication processing, the image processor to execute the image processing corresponding to the received image processing instruction.

2. The image processing apparatus according to claim 1, wherein
the communicator is configured to execute wireless communication with a plurality of wireless communication terminals comprising the wireless communication terminal, and
the controller is configured to perform, after the wireless communication terminal acquires the first authentication information, priority control of prioritizing the image processing instruction from the wireless communication terminal over an image processing instruction from a different wireless communication terminal for a predetermined period.

3. The image processing apparatus according to claim 2, wherein
the controller is configured to perform, as the priority control, control of not receiving the image processing instruction from the different wireless communication terminal.

4. The image processing apparatus according to claim 2, wherein
the controller is configured to perform, as the priority control, control of receiving the image processing instruction from the different wireless communication terminal and suspending the image processing instruction from the different wireless communication terminal until the predetermined period elapses.

5. The image processing apparatus according to claim 2, wherein
the predetermined period is a period until completion of the image processing corresponding to the image processing instruction from the wireless communication terminal, and the controller is configured to end the priority control in response to the completion.

6. The image processing apparatus according to claim 2, wherein
the controller is configured to control, when performing the priority control, the communicator to transmit a notification regarding the priority control to the different wireless communication terminal.

7. The image processing apparatus according to claim 6, wherein
the controller is configured to:
identify a user of the wireless communication terminal, and
control the communicator to transmit the notification comprising information of the identified user to the different wireless communication terminal.

8. The image processing apparatus according to claim 1, wherein
the presentation unit is configured to present the first authentication information in such a manner that the wireless communication terminal approaching the image processing apparatus is allowed to directly acquire the first authentication information from the image processing apparatus.

9. The image processing apparatus according to claim 8, wherein
the presentation unit comprises a display configured to perform the presentation by displaying a code obtained by encoding the first authentication information and/or a Near Field Communication (NFC) communicator configured to perform the presentation by transmitting the first authentication information through NFC communication.

10. The image processing apparatus according to claim 1, wherein
the controller is configured to select one of a first mode in which the image processing corresponding to the image processing instruction is executed on condition that the authentication processing is successful and a second mode in which the image processing corresponding to the image processing instruction is executed without performing the authentication processing.

11. The image processing apparatus according to claim 10, wherein
the controller is configured to control, based on selection of the first mode, the communicator to transmit, to the wireless communication terminal, a notification indicating that the first mode is selected.

12. The image processing apparatus according to claim 10, wherein
the controller is configured to:
select the first mode based on the communicator being in wireless communication with a plurality of wireless communication terminals, and
select the second mode based on the communicator being in wireless communication with only one wireless communication terminal.

13. The image processing apparatus according to claim 10, further comprising:
an operator configured to receive a user operation, wherein
the controller is configured to:
select the first mode based on the operator receiving a predetermined operation designating the first mode, and
select the second mode based on the operator not receiving the predetermined operation.

14. The image processing apparatus according to claim 10, wherein
the controller is configured to:
select the first mode based on the communicator receiving, through wireless communication, a predetermined signal designating the first mode, and
select the second mode based on the communicator not receiving the predetermined signal.

15. The image processing apparatus according to claim 10, wherein
the controller is configured to:
control, based on selection of the first mode, the presentation unit to present the first authentication information, and
control, based on selection of the second mode, the presentation unit not to present the first authentication information.

16. A wireless communication terminal comprising:
a communicator configured to perform wireless communication with an image processing apparatus configured to execute image processing comprising printing and/or scanning;
an acquiring unit configured to acquire authentication information presented by the image processing apparatus; and
a controller configured to control the communicator to transmit, to the image processing apparatus through the wireless communication, the acquired authentication information and an image processing instruction instructing execution of the image processing.

17. The wireless communication terminal according to claim 16, further comprising:
a display, wherein
the communicator is configured to receive, from the image processing apparatus, a notification indicating that the image processing apparatus has selected the first mode,
the first mode is a mode in which the image processing corresponding to the image processing instruction is executed on a condition of success in authentication processing of checking whether authentication information presented by the image processing apparatus matches authentication information transmitted by the wireless communication terminal, and
the controller is configured to cause, based on the notification, the display to display a screen prompting a user to acquire authentication information presented by the image processing apparatus.

18. The wireless communication terminal according to claim 16, wherein
the acquiring unit is configured to acquire the authentication information in such a manner that the wireless communication terminal approaching the image processing apparatus is allowed to directly acquire the authentication information from the image processing apparatus.

19. The wireless communication terminal according to claim 18, wherein
the acquiring unit comprises an imager configured to image a code obtained by encoding the authentication information and/or a Near Field Communication (NFC) communicator configured to receive the authentication information through NFC communication.

20. A program causing an image processing apparatus configured to execute image processing comprising printing and/or scanning to execute:
presenting first authentication information configured to be acquired by a wireless communication terminal;
receiving, from the wireless communication terminal through wireless communication with the wireless communication terminal, an image processing instruction instructing execution of the image processing and second authentication information associated with the image processing instruction;
performing authentication processing of checking whether the received second authentication information matches the presented first authentication information; and
executing, based on success in the authentication processing, the image processing corresponding to the received image processing instruction.
